(19) United States
(12) Patent Application Publication
(10) Pub. No.: US 2023/0002541 A1
(43) Pub. Date: Jan. 5, 2023

(54) COMPOSITION FOR FORMING POLYURETHANE FOAM

(71) Applicant: Covestro Intellectual Property GmbH & Co. KG, Leverkusen (DE)

(72) Inventors: Yuka IMOTO, Higashinada-ku, Kobe, Hyogo (JP); Saeko MATZUSAWA, Amagasaki City (JP); Shinichiro SADO, Sanda City, Hyogo (JP)

(21) Appl. No.: 17/783,749

(22) PCT Filed: Dec. 17, 2020
(86) PCT No.: PCT/EP2020/086610

§ 371 Date: Jun. 9, 2022

(30) Foreign Application Priority Data
Dec. 23, 2019 (JP) 2019231423
Mar. 4, 2020 (EP) 20161050.8

(51) Int. Cl. C08G 18/08; C08G 18/10; C08G 18/20; C08G 18/48; C08J 9/12

(52) U.S. Cl. CPC C08G 18/14; C08G 18/10; C08G 18/2027; C08G 18/2081; C08G 18/485; C08J 9/125; C08G 2101/00

(57) ABSTRACT

The present invention provides a composition which is capable of forming a polyurethane foam having a high hardness and excellent sound absorption properties. [Solution] The present invention relates to a composition for forming polyurethane foam characterized in that the composition for forming polyurethane foam comprises a polyol, a polyisocyanate, and a catalyst, in which the polyol comprises a polyol (A) having a number average molecular weight of 1500 to 8000 g/mol, the catalyst comprises a trimerization catalyst, in which the polyurethane foam has an air permeability of not less than 0.1 L/sec.

### TECHNICAL FIELD

The present invention relates to a composition for forming polyurethane foam, in particular polyurethane semi-rigid foam, and polyurethane foam, in particular polyurethane semi-rigid foam, which is formed by the composition. Specifically, the present invention relates to a composition which is capable of forming a polyurethane foam having a high hardness and excellent sound absorption properties.

### BACKGROUND ART

As a measure for reducing the environmental load of motor vehicles, efforts to improve fuel economy of the motor vehicles have been made. Since fuel economy decreases as the weight of a motor vehicle increases, weight reduction of the motor vehicle is highly effective at improving fuel economy. On the other hand, since the number of apparatuses mounted on a motor vehicle is increasing for the purpose of improving the safety and comfortability of the motor vehicle, it is desired to minimize the weight of each of the components of the motor vehicle.

For example, an engine cover is mounted around an engine of a motor vehicle for improving the sound insulation performance and style, and a resin foam material is proposed as a material used for the engine cover for the purpose of weight reduction.

JP 2002-28934 A (Patent Literature 1) discloses an engine cover having a urethane foam resin layer, which is formed by foaming a two-pack urethane foam resin composition at ordinary temperature into a shape which fits projections and depressions of the outer surface of an engine, on the back side of a resin or metal cover. Patent Literature 1 suggests that the engine cover exerts excellent sound-insulating and vibration-insulating effects.

JP 2006-265467 A (Patent Literature 2) discloses a sound and vibration insulating material for vehicles in which the sound and vibration insulating material comprises flexible polyurethane foam which is obtained by reacting an organic polyisocyanate component with a polyol component and foaming, in which the organic polyisocyanate component contains 2,4′-diphenylmethane diisocyanate, 4,4′-diphenylmethane diisocyanate, a polynuclear isocyanate, and a prepolymer-form isocyanate in specific proportions, and the flexible polyurethane foam has a specific density, a specific 50% compressive load, and incombustibility. Patent Literature 2 suggests that the sound and vibration insulating material realizes both an excellent flame retardance and an excellent heat deterioration resistance, and can provide a sound and vibration insulating material for vehicles having an improved sound-absorption performance in a high frequency region even at a low cost.

### CITATION LIST

Patent Document
Patent Literature 1: JP 2002-28934 A
Patent Literature 2: JP 2006-265467 A

### SUMMARY OF INVENTION

### Technical Problem

An engine cover disclosed in Patent Literature 1 comprises a resin or metal cover and a urethane foam resin layer. However, the engine cover is preferably formed of urethane foam alone to achieve further weight reduction. However, to improve the sound insulation performance, flexible polyurethane foam having an open cell-type cell structure is preferred. For constituting components using the foam alone, there is a room for improvement in strength (hardness). Actually, the sound and vibration insulating material disclosed in Patent Literature 2 is defined as constituted by flexible polyurethane foam. However, Patent Literature 2 lacks sufficient consideration about hardness.

Accordingly, an object of the present invention is to solve the above-described problems of prior art, and to provide a composition which is capable of forming polyurethane foam having a high hardness and excellent sound absorption properties. Another object of the present invention is to provide a polyurethane foam obtained from the composition.

### Solution to Problem

The present inventors, after pursuing a diligent study to accomplish the above-described objects, have found that when a trimerization catalyst is used for formulating a composition containing a polyol having a number average molecular weight of 1500 to 8000 g/mol as used in flexible polyurethane foam, polyurethane foam having a high hardness and excellent sound absorption properties can be obtained, and have made the present invention.

That is, a composition for forming polyurethane foam according to the present invention is characterized in that the composition for forming polyurethane foam comprises a polyol, a polyisocyanate, and a catalyst, wherein the polyol comprises a polyol (A) having a number average molecular weight of 1500 to 8000 g/mol, wherein the catalyst comprises a trimerization catalyst, and wherein the polyurethane foam has an air permeability of not less than 0.1 L/sec.

In a preferred embodiment of the composition for forming polyurethane foam according to the present invention, the polyol (A) has a hydroxyl value of 20 to 60 mg KOH/g.

In another preferred embodiment of the composition for forming polyurethane foam according to the present invention, the polyol (A) accounts for not less than 90% by mass of the polyol.

In another preferred embodiment of the composition for forming polyurethane foam according to the present invention, the composition has an isocyanate index of 70 to 300.

In another preferred embodiment of the composition for forming polyurethane foam according to the present invention, the polyurethane foam has a density of 60 to 250 kg/m³.

In another preferred embodiment of the composition for forming polyurethane foam according to the present invention, the polyurethane foam has an Asker F hardness of not less than 90. In a particularly preferred embodiment of the composition for forming polyurethane foam, in particular polyurethane semi-rigid foam, according to the present invention, the polyol (A) has a hydroxyl value of 20 to 60 mg KOH/g and/or accounts for not less than 90% by mass of the polyol, and/or the composition has an isocyanate index of 70 to 300, and/or the polyurethane foam, in particular polyurethane semi-rigid foam, has a density of 60 to 250 kg/m³, and/or the polyurethane foam, in particular polyurethane semi-rigid foam has an Asker F hardness of not less than 90.

A polyurethane foam according to the present invention is characterized in that the polyurethane foam is formed by the above-described composition for forming polyurethane foam.

### Advantageous Effect of Invention

According to the present invention, a composition which is capable of forming polyurethane foam having a high hardness and excellent sound absorption properties, and a polyurethane foam which is formed by the composition can be provided.

### DESCRIPTION OF EMBODIMENTS

A composition for forming polyurethane foam according to the present invention (hereinafter, also simply referred to as a “composition according to the present invention”) is described below in detail. The composition according to the present invention is a composition comprising a polyol, a polyisocyanate, and a catalyst, in which the composition is used for forming polyurethane foam. The composition according to the present invention can be also referred to as a raw material composition for polyurethane foam.

The polyol used for a composition according to the present invention is a compound having two or more hydroxyl groups, and generally refers to a polymeric polyol.

Specific examples of the polyol include a polyether polyol, a polyester polyol, a polycarbonate polyol, a polyester-ether polyol, a polyester polycarbonate polyol, a polylactone polyol, a polybutadiene polyol, and a polymer polyol. The polyols may be used alone or in combination of two or more.

In the composition according to the present invention, the content of the polyol is suitably adjusted according to the amount of a polyisocyanate, and an example of the content is 50 to 85% by mass.

Among the above-described polyols, examples of the polyether polyol include a polyaddition product of a cyclic ether, and a condensation product of a polyhydric alcohol. Examples of the cyclic ether include styrene oxide, ethylene oxide, propylene oxide, tetrahydrofuran, butylene oxide, and epichlorohydrin. These cyclic ethers may be used alone or in combination of two or more. Examples of the polyhydric alcohol include diols such as ethanediol, diethylene glycol, triethylene glycol, tetraethylene glycol, 1,2-propanediol, dipropylene glycol, tripropylene glycol, tetrapropylene glycol, 1,3-propanediol, 1,4-butanediol, 1,3-butanediol, 2,3-butanediol, 1,5-pentanediol, 1,6-hexanediol, 2,2-dimethyl-1,3-propanediol, 1,4-dihydroxycyclohexane, 1,4-dimethylolcyclohexane, 1,8-octanediol, 1,10-decanediol, and 1,12-dodecanediol; and three or more functional polyols such as trimethylolpropane, glycerol, and pentaerythritol. These polyhydric alcohols may be used alone or in combination of two or more. A known polyaddition product of tetrahydrofuran is, for example, poly(tetramethylene ether)glycol (PTMG).

The polyester polyol can be manufactured by controlling conditions for the manufacture of a polyester. Examples of the polyester polyol include a polyester having hydroxyl groups at at least both ends of the main chain. More specifically, examples include a linear polyester polyol, a slightly branched polyester polyol, and the like. Polyester polyols can be prepared by a known method using an aliphatic, alicyclic, or aromatic dicarboxylic acid, a diol, and optionally a polyvalent carboxylic acid and/or a three or more functional polyol.

The polylactone polyol is a homopolymer of a lactone or a copolymer of lactones such as ε-caprolactone, β-butyrolactone, γ-butyrolactone, γ-valerolactone, and δ-valerolactone. Examples of the polylactone polyol include a polylactone having hydroxyl groups at at least both ends of the main chain, and the like.

The polycarbonate polyol can be manufactured by controlling conditions for the manufacture of a polycarbonate. Examples of the polycarbonate polyol include a polycarbonate having hydroxyl groups at at least both ends of the main chain, and the like. Examples of the polybutadiene polyol include a polybutadiene having hydroxyl groups at at least both ends of the main chain, and the like. Examples of the polymer polyol include a polymer polyol which can be obtained by polymerizing a vinyl monomer such as acrylonitrile or styrene in a polyether polymer.

The polyol used for a composition according to the present invention comprises, from the standpoint of air permeability and sound absorption properties of a polyurethane foam, a polyol (A) having a number average molecular weight of 1500 to 8000 g/mol. Herein, a polyol having a number average molecular weight within the range specified above is denoted by a polyol (A). The polyol (A) preferably has a number average molecular weight of 2000 to 6000 g/mol. Herein, the number average molecular weight refers to a number average molecular weight versus polystyrene standards as measured by gel permeation chromatography.

The polyol (A) has a hydroxyl value of, from the standpoint of air permeability and sound absorption properties of a polyurethane foam, preferably 20 to 70 mg KOH/g, more preferably 20 to 60 mg KOH/g, and particularly preferably 25 to 60 mg KOH/g. The hydroxyl value refers to an amount in milligram of potassium hydroxide required for neutralizing acetylated hydroxy groups in 1 g of a sample after complete acetylation of free hydroxy groups in the sample with acetic anhydride (see JIS K 1557 2007).

The number of functional groups (fn) in the polyol is preferably 2 to 6, more preferably 2 to 4, and particularly preferably 2 to 3. The number of functional groups (fn) in one polyol molecule can be calculated from a hydroxyl value (OHV) and a number average molecular weight (Mn) of the polyol using the following formula.

fn=Mn(g/mol)×OHV(mg KOH/g)/56100

In a composition according to the present invention, from the standpoint of air permeability and sound absorption properties of a polyurethane foam, the polyol (A) preferably accounts for not less than 90% by mass of the polyol, and the polyol (A) may account for the whole of the polyol.

The polyisocyanate used for a composition according to the present invention is a compound having two or more isocyanate groups. Examples of the polyisocyanate include an aromatic, aliphatic, araliphatic, or alicyclic polyisocyanate, and also include modified forms of these polyisocyanates. Examples of the modified forms of the polyisocyanates include polyisocyanates having a structure of uretdione, uretoimine, isocyanurate, urethane, urea, allophanate, biuret, carbodiimide, iminooxadiazinedione, oxadiazinetrione, oxazolidone or the like. Further, as the above-described polyisocyanate, an isocyanate group-containing prepolymer obtained by reacting a polyol with a polyisocyanate may be used. These polyisocyanates may be used alone or in combination of two or more.

Among the above-described polyisocyanates, examples of the aromatic polyisocyanate include 1,3- and/or 1,4-phenylene diisocyanate, 2,4- and/or 2,6-tolylene diisocyanate (TDI), a polymeric TDI (also referred to as a crude TDI), 2,4′- and/or 4,4′-diphenylmethane diisocyanate (MDI), a polymethylene polyphenyl isocyanate (also referred to as a crude MDI or a polymeric MDI), a polyaryl polyisocyanate (PAPI). The aliphatic polyisocyanate is preferably aliphatic diisocyanates having 2 to 18 carbon atoms, and specific examples include 1,6-hexamethylene diisocyanate, lysine diisocyanate, and the like. The alicyclic polyisocyanate is preferably alicyclic diisocyanates having 4 to 16 carbon atoms, and specific examples include isophorone diisocyanate (IPDI), 4,4′-dicyclohexylmethane diisocyanate, norbornane diisocyanate, and the like.

The above-described polyisocyanate preferably has an isocyanate-group content of 20 to 50% by mass, and more preferably 25 to 35% by mass. Herein, the isocyanate-group content can be obtained according to JIS K 1603.

In a composition according to the present invention, the content of a polyisocyanate can be represented by, for example, an isocyanate index. In a composition according to the present invention, from the standpoint of hardness and flame retardance of a polyurethane foam, a higher isocyanate index is preferred. Specifically, the isocyanate index is preferably 70 to 300, and more preferably 80 to 150. Herein, the isocyanate index is a value obtained by multiplying a ratio of isocyanate groups of a polyisocyanate to the total of active hydrogens that react with the isocyanate groups of a polyol and a foaming agent, or the like, by 100.

The catalyst used for a composition according to the present invention comprises a trimerization catalyst. The trimerization catalyst refers to a catalyst which accelerates a trimerization reaction of isocyanates (i.e., the formation of an isocyanurate ring). By the formation of an isocyanurate ring structure in polyurethane foam, hardness and flame retardance of a polyurethane foam can be increased. Examples of the trimerization catalyst include aromatic compounds such as 2,4,6-tris(dialkylaminoalkyl)hexahydro-S-triazine, 1,3,5-tris(N,N-dimethylaminopropyl)hexahydro-S-triazine, 2,4,6-tris(dimethylaminomethyl)phenol, 2,4-bis(dimethylaminomethyl)phenol, and 1-isobutyl-2-methylimidazole; alkali metal carboxylates such as potassium acetate, potassium 2-ethylhexanoate, and potassium octylate; and a quaternary ammonium salt of a carboxylic acid; or other onium salts. In a composition according to the present invention, the content of a trimerization catalyst is preferably 0.3 to 1.5% by mass, and more preferably 0.5 to 1.0% by mass. The trimerization catalysts may be used alone or in combination of two or more.

The catalyst used for a composition according to the present invention may further comprises another catalyst. Preferred examples of other catalysts include a catalyst which accelerates a reaction between water and an isocyanate (a foaming catalyst), and a catalyst which accelerates a reaction between a polyol and an isocyanate (a resinification catalyst). Although the catalyst used for a composition according to the present invention comprises at least a trimerization catalyst, the catalyst preferably comprises a foaming catalyst, a resinification catalyst, and a trimerization catalyst. When a composition according to the present invention comprises a catalyst other than a trimerization catalyst, the content of the total catalysts in the composition is, for example, 0.3 to 3.0% by mass.

Examples of the foaming catalyst include dimorpholine-2,2-diethyl ether, N,N,N′,N″,N″-pentamethyldiethylenetriamine, bis(dimethylaminoethyl) ether, and 2-(2-dimethylaminoethoxy)ethanol. The foaming catalysts may be used alone or in combination of two or more.

Examples of the resinification catalyst include amine catalysts such as triethylenediamine, N,N-dimethylcyclohexylamine, N,N,N′,N′-tetramethylethylenediamine, N,N,N′,N″,N′″,N′″-hexamethyltriethylenetetramine, N-dimethylaminoethyl-N′-methylpiperazine, N,N,N′,N′-tetramethylhexamethylenediamine, 1,2-dimethylimidazole, N,N-dimethylaminopropylamine, and bis(dimethylaminopropyl)amine; alkanolamine catalysts such as N,N-dimethylaminoethanol, N,N,N′-trimethylaminoethylethanolamine, N,N,N′-trimethyl-N′-hydroxyethylbisaminoethyl ether, N-(3-dimethylaminopropyl)-N,N-diisopropanolamine, N-(2-hydroxyethyl)-N′-methylpiperazine, N,N-dimethylaminohexanol, and 5-dimethylamino-3-methyl-1-pentanol; and metal catalysts such as tin(II) octylate, dibutyltin(IV) dilaurate, lead octylate, bismuth carboxylate, and a zirconium complex. The resinification catalysts may be used alone or in combination of two or more.

A composition according to the present invention, in general, preferably comprises a foaming agent. The foaming agents which can be used for a composition according to the present invention are generally classified into physical foaming agents or chemical foaming agents. Specific examples of the physical foaming agent include fluorocarbons such as a hydrochlorofluorocarbon (HCFC) and a hydrofluorocarbon (HFC); a hydrofluoroolefin (HFO); hydrocarbons such as heptane, hexane, and pentane; and carbon dioxide. Examples of the chemical foaming agent include water; and carboxylic acids such as formic acid and acetic acid. The foaming agents may be used alone or in combination of two or more. The physical foaming agent may be used in combination with the chemical foaming agent. In the composition according to the present invention, the content of a foaming agent in a polyol component is preferably 0.4 to 2.5% by mass, and more preferably 0.5 to 2.0% by mass.

A composition according to the present invention may comprise a foam stabilizer. As a foam stabilizer, a surfactant is preferably used. Examples of the surfactant include ionic surfactants such as anionic, cationic, and amphoteric surfactants, and nonionic surfactants, and nonionic surfactants are preferred. Specific examples preferably include a silicone-based surfactant and a fluorine-based surfactant. In the composition according to the present invention, the content of the foam stabilizer is preferably 0.1 to 5% by mass, and more preferably 0.2 to 2% by mass. The foam stabilizers may be used alone or in combination of two or more.

A composition according to the present invention may further comprise a flame retardant. As a flame retardant, a phosphorus flame retardant is preferably used. Specific examples preferably include tricresyl phosphate (TCP), triethyl phosphate (TEP), tris(β-chloroethyl)phosphate (TCEP), and tris(β-chloropropyl)phosphate (TCPP). In the composition according to the present invention, the content of the flame retardant is preferably 2 to 15% by mass. The flame retardants may be used alone or in combination of two or more.

In a composition according to the present invention, other components such as a cross-linking agent, a colorant, a filler, an antioxidant, an ultraviolet absorber, a heat stabilizer, a light stabilizer, a plasticizer, a fungicide, an antimicrobial agent, a solvent, a viscosity-reducing agent, and a pressure-reducing agent may be suitably included, if necessary. Commercially available products can be preferably used as these components.

A composition according to the present invention comprises a polyol component and a polyisocyanate component. The polyol component contains a polyol, and generally contains a foaming agent, a foam stabilizer, a flame retardant, a catalyst, or the like. The polyisocyanate component comprises a polyisocyanate, and may contain an additive such as a foaming agent or a flame retardant. The composition according to the present invention is constituted by a stock solution comprising a combination of the polyol component and the polyisocyanate component, and thus is also referred to as a two-pack-type composition.

A composition according to the present invention can be prepared by mixing various kinds of components which are suitably selected according to requirements. For example, by mixing a polyol component containing a polyol and a catalyst with a polyisocyanate component comprising a polyisocyanate, a composition according to the present invention can be prepared.

A composition according to the present invention is a composition used for forming polyurethane foam. The polyurethane foam preferably has an air permeability of not less than 0.1 L/sec, preferably has a density of 60 to 250 kg/m³, and preferably has an Asker F hardness of not less than 90.

Next, a polyurethane foam according to the present invention is described in detail. A polyurethane foam according to the present invention is formed from the above-described composition for forming polyurethane foam according to the present invention. Since the composition according to the present invention comprises a polyol and a polyisocyanate, a reaction proceeds by mixing both compounds, which enables formation of a polyurethane foam. The method for manufacturing a polyurethane foam is not particularly limited, and known molding means such as slab molding, mold molding, and the like can be used.

A polyurethane foam according to the present invention can be used in various fields such as fields of vehicle, apparatus, furniture, bedding, interior, wrapping, daily goods, clothing, and the like, and is preferably used as a sound-absorbing material because the polyurethane foam has excellent sound absorption properties. In addition, a polyurethane foam according to the present invention has a high hardness and flame retardance, and thus is preferably used for components placed around an engine of a motor vehicle or the like, and, in particular, preferably used for an engine cover.

A polyurethane foam according to the present invention preferably has air permeability of not less than 0.1 L/sec, and more preferably not less than 0.5 L/sec. When air permeability of the polyurethane foam is within the range specified above, sound absorption properties can be improved. The upper limit of air permeability of the polyurethane foam according to the present invention is not particularly limited, and may be, for example, not more than 2 L/sec. Herein, air permeability of a polyurethane foam is measured according to Method A defined in JIS K6400-7 (negative pressure method).

A polyurethane foam according to the present invention preferably has a density of 60 to 250 kg/m³, more preferably 80 to 250 kg/m³, and particularly preferably 80 to 150 kg/m³. Herein, density of a polyurethane foam is measured according to JIS K 7222:2005.

A polyurethane foam of the present invention preferably has an Asker F hardness of not less than 90. Herein, the Asker F hardness is represented by a value obtained using an Asker Durometer Type F for rubber.

Components placed around an engine according to the present invention is characterized by comprising a polyurethane foam according to the present invention described above, and an engine cover according to the present invention is characterized by comprising a polyurethane foam according to the present invention described above. Since these inventive materials comprise a polyurethane foam according to the present invention, the materials are superior in hardness and sound absorption properties, and preferably further superior in flame retardance. Examples of the component placed around an engine of a motor vehicle or the like include, in addition to an engine cover, an oil pan or the like.

### EXAMPLES

The present invention is further described below in detail with reference to Examples, but the present invention is not limited to Examples described below in any way.

<Raw Materials>

Materials used for manufacturing a polyurethane foam are shown below.

Polyol A: a polyol manufactured by Sumika Covestro Urethane Co., Ltd. (a propoxylated triol having a number average molecular weight of 4,800, approximately 3 functional groups, and an OH value of 35 mg KOH/g, and comprising glycerin, propylene oxide, and ethylene oxide as constituent units)

Polyol B: a polyol manufactured by Sumika Covestro Urethane Co., Ltd. (a propoxylated triol having a number average molecular weight of 360, approximately 3 functional groups, and an OH value 470 mg KOH/g, and comprising glycerin, propylene oxide, and ethylene oxide as constituent units)

Polyisocyanate A: a polyisocyanate manufactured by Sumika Covestro Urethane Co., Ltd. [a liquid carbodiimide-modified diphenylmethane diisocyanate (NCO content=29% by mass)]

Silicone A: TEGOSTAB B8715LF2 manufactured by EVONIK

Silicone B: NIAX-SILICONE L3601 manufactured by Momentive

Catalyst A: DABCO BL11 manufactured by EVONIK

Catalyst B: DABCO 2040 manufactured by EVONIK

Catalyst C: DABCO K15 manufactured by EVONIK

Flame retardant: TMCPP manufactured by DAIHACHI CHEMICAL INDUSTRY CO., LTD.

Foaming agent: water

<Example of Manufacturing Polyurethane Foam>

Using an injection molding apparatus, a two-part reaction-type composition for forming polyurethane foam obtained from a polyol component and a polyisocyanate component was injected into a mold, which was reacted and cured to form polyurethane foam.

For manufacturing a polyurethane foam-molded article, a reaction injection molding machine manufactured by Polymer Engineering Co., LTD. was used.

The following conditions were used for carrying out the manufacture.

The temperature of raw materials, which were a polyol component and a polyisocyanate component, was 30° C.

The discharging rate of a polyol component and a polyisocyanate component was 150 g/sec.

The discharging pressure of a polyol component and a polyisocyanate component was 14 MPa.

The temperature of a mold was 55° C., and the curing time between injection into and removal from a mold was 5 minutes.

Formulations of polyol component, mass ratios in compositions (polyol component/polyisocyanate component), isocyanate indexes, and densities of polyurethane foams obtained by foaming and curing the compositions are shown in Table 1. As the polyisocyanate component, polyisocyanate A was used.

The manufactured polyurethane foam was evaluated for sound absorption properties, hardness, and flame retardance. The results are shown in Table 1.

<Air Permeability>

Air permeability of a polyurethane foam was measured according to Method A defined in JIS K6400-7 (negative pressure method).

<Sound Absorption Properties>

Sound absorption properties of a polyurethane foam were measured according to JIS A 1405-2:2007.

Measurement of sound absorbability was carried out at wavelengths of 63 Hz to 5000 Hz, and the result of average sound absorbability was used for comparison.

<Hardness>

Using an Asker Durometer Type F for rubber, hardness of a polyurethane foam was measured, and the result was evaluated for hardness according to the following criteria. The measurement was carried out at 25° C.

<Flame Retardance>

A combustion test was carried out according to a method defined in FMVSS 302 to evaluate flame retardance of a polyurethane foam.

Evaluation Criteria

◯: Self-extinguishing properties

Δ: Slow-flammable properties

x: Highly-flammable properties

TABLE 1

| | | | Example | Example | Example | Example | Example | Example | Comparative | Comparative | Comparative |
|---|---|---|---|---|---|---|---|---|---|---|---|
| | | | 1 | 2 | 3 | 4 | 5 | 6 | Example 1 | Example 2 | Example 3 |
| Formulation | Polyol A | Part | 100 | 100 | 100 | 100 | 100 | 100 | 100 | — | 100 |
| of polyol | Polyol B | by | — | — | — | — | — | — | — | 100 | — |
| component | Silicone | mass | 1 | 1 | 1 | 1 | 1 | 1 | 1 | 1 | — |
| | A | | | | | | | | | | |
| | Silicone | | — | — | — | — | — | — | — | — | 1 |
| | B | | | | | | | | | | |
| | Catalyst | | 0.2 | 0.2 | 0.2 | 0.2 | 0.2 | 0.2 | 0.2 | 0.2 | 0.2 |
| | A | | | | | | | | | | |
| | Catalyst | | 0.2 | 0.2 | 0.2 | 0.2 | 0.2 | 0.2 | 0.2 | 0.2 | 1 |
| | B | | | | | | | | | | |
| | Catalyst | | 0.5 | 0.5 | 0.5 | 0.5 | 0.5 | 0.5 | 0 | 0.5 | 0.5 |
| | C | | | | | | | | | | |
| | Flame | | 0 | 0 | 0 | 0 | 0 | 10 | 0 | 0 | 0 |
| | retardant | | | | | | | | | | |
| | Foaming | | 1 | 1 | 1 | 1.2 | 0.8 | 1 | 1 | 1 | 3 |
| | agent | | | | | | | | | | |
| | (water) | | | | | | | | | | |

| | | | | | | | | | |
|---|---|---|---|---|---|---|---|---|---|
| Mass ratio in composition | 100/18.5 | 100/27.8 | 100/46.3 | 100/31.6 | 100/24.1 | 100/25.3 | 100/23.4 | 100/155 | 100/75.3 |
| (polyol | | | | | | | | | |
| component/polyisocyanate | | | | | | | | | |
| component) | | | | | | | | | |
| Isocyanate index | 80 | 120 | 200 | 120 | 120 | 120 | 120 | 120 | 120 |
| Density (kg/m³) | 100 | 100 | 100 | 80 | 250 | 100 | 100 | 100 | 40 |
| Air permeability (L/sec) | 0.6 | 0.5 | 0.3 | 0.6 | 0.3 | 0.5 | 0.8 | 0 | 1.2 |
| Average sound absorbability | 62 | 46 | 34 | 51 | 33 | 45 | 70 | 12 | 82 |
| (%) | | | | | | | | | |
| Hardness (Asker F) | 95 | 99 | 100 | 97 | 100 | 99 | 60 | 100 | 74 |
| Flame retardance | O | O | O | O | O | O | Δ | O | Δ |
| (FMVSS 302) | | | | | | | | | |

1. A composition for forming a polyurethane foam, the composition comprising a polyol, a polyisocyanate, and a catalyst, wherein the polyol comprises a polyol (A) having a number average molecular weight of 1500 to 8000 g/mol, wherein the catalyst comprises a trimerization catalyst, and wherein the polyurethane foam has an air permeability of not less than 0.1 Usec and an Asker F hardness of not less than 90.

2. The composition for forming a polyurethane foam according to claim 1, wherein the polyol (A) has a hydroxyl value of 20 to 60 mg KOH/g.

3. The composition for forming &polyurethane semi rigid foam according to claim 1, wherein the polyol (A) accounts for not less than 90% by mass of the polyol.

4. The composition for forming a polyurethane foam according to claim 1, wherein the composition has an isocyanate index of 70 to 300.

5. The composition for forming a polyurethane foam according to claim 1, wherein the polyurethane foam has a density of 60 to 250 kg/m³.

6. A polyurethane foam formed by the composition for forming a polyurethane foam according to claim 1.
